(19) United States
(12) Patent Application Publication
(10) Pub. No.: US 2015/0102604 A1
(43) Pub. Date: Apr. 16, 2015

(54) Energy from Ocean Waves

(71) Applicant: Rohan Patel, Bensalem, PA (US)

(72) Inventor: Rohan Patel, Bensalem, PA (US)

(21) Appl. No.: 14/303,569

(22) Filed: Jun. 12, 2014

Related U.S. Application Data
(60) Provisional application No. 61/973,796, filed on Apr. 1, 2014.

(51) Int. Cl. F03B 13/18

(52) U.S. Cl. CPC F03B 13/1885
USPC 290/53

(57) ABSTRACT

The invention provides a very cost effective and very simple option to generate energy from ocean waves with minimum investment possible. It basically is a round shaped floating object with multiple generators on edge evenly part from one another. Each generator tied to the ocean floor with cable on angel. The ocean wave moves the 15 disc around which results a motion in generators. This generates electricity. This design can be used as a private power house for some island resorts too.

This Application claims Priority to Provisional Application No. 61/973,796 filed on date Apr. 1, 2014.

### FIELD OF THE INVENTION

The present invention relates generally to renewable energy and green energy systems. More specifically, the present invention is a renewable energy system based on ocean surface waves.

### BACKGROUND OF THE INVENTION

Renewable energy systems involve the use of resources that are continuously replenished such as sunlight, wind, rain, oceanic tides and waves, and geothermal heat. Renewable energy systems are favorable due to their ability to provide sustainable energy with largely reduced impact on the environment. The reduced environmental impact of renewable energy systems is particularly favorable relative to electricity generation from burning fossil fuel sources such as petroleum, coal, and natural gas. Fossil fuels yield a significantly high amount of energy relative to units burned. However, this benefit comes at the cost of increased greenhouse gas emissions into the atmosphere from the combustion of fossil fuels. Additionally, because fossil fuels generally form over millions of years, they are considered a non-renewable source of energy. Perhaps the most prominent consequence of greenhouse gas emissions is the progressive increase in the temperature of the Earth's atmosphere and oceans. Increased greenhouse gas emissions along with factors such as deforestation have led to warming of the Earth's climate system. The problem is projected to worsen in the future as the Earth's population increases, leading to a corresponding increase in energy demand and consumption. The consequences of the Earth's increasing temperature are perhaps most visible in the gradual decline of the Arctic sea ice over the years. The melting of the polar icecap has resulted in a rising of the sea level as well. Numerous ecosystems of the Earth negatively affected by rising temperatures and increased atmospheric CO₂ concentrations. Renewable energy systems greatly reduce the impact on the Earth's environment. However, despite technological advancements in renewable energy systems in recent years, renewable energy systems remain underutilized. Renewable energy systems hold a relatively low percentage share relative to conventional (fossil fuel) energy systems.

The present invention is a renewable energy system based on ocean surface waves. The present invention seeks to harness the energy transported by ocean surfaces for useful work. In the preferred embodiment of the present invention, the renewable energy system comprises a platform. The platform is buoyant and serves as abuse structure for a plurality of energy generation units. The platform is preferably circular in design with the energy generation units positioned along the circumference of the platform. Each energy generation unit comprises a support structure with pivot mechanism, a fork with gear teeth, a first (small) gear, a second (large) gear, and an electrical generator. The fork is capable of pivoting about the support structure and is anchored to the ocean floor. The fork comprises gear teeth that are capable of engaging the teeth of the small gear, causing the small gear to spin. The rotation of the small gear is translated to the large gear via a one-way clutch. The large gear is connected to the electrical generator allowing the rotational movement provided by the small gear and large gear to spin the electrical generator. Following each stroke of the fork, the fork is brought back to the original position via the one-way clutch and a return mechanism.

The renewable energy system seeks to harness the energy transported by ocean surface waves and as such may be based at an appropriate offshore location. As previously discussed, the buoyant platform is able to float on the ocean surface while energy generation units are anchored to the ocean floor. The movement of the ocean waves causes the forks of the energy generation units to pivot about their support structures.

### SUMMARY OF THE INVENTION

The present invention is a very cost effective and low investment mechanism far Renewable Energy Generation. The invention converts motion waves in to electricity with use of floating disc. The floating disc is surrounded is generators on its edge. Each generator is tied to the ocean floor with help of anchor. Every time disc moves in any direction generates electricity in generators.

### BRIEF DESCRIPTION OF THE DRAWINGS

FIG. 1 is an isometric view of the renewable energy system.

FIG. 2 is a front view of the renewable energy system.

FIG. 3 is a top view of the renewable energy system.

FIG. 4 is a front view of the renewable energy system with a single pair of energy generation units.

FIG. 5 is a front internal view of the renewable energy system with a single pair of energy generation units.

FIG. 6 is a front view of the renewable energy system with a single pair of energy generation units and anchors of uneven lengths.

### DETAIL DESCRIPTIONS OF THE INVENTION

All illustrations of the drawings are for the purpose of describing selected versions of the present invention and are not intended to limit the scope of the present invention.

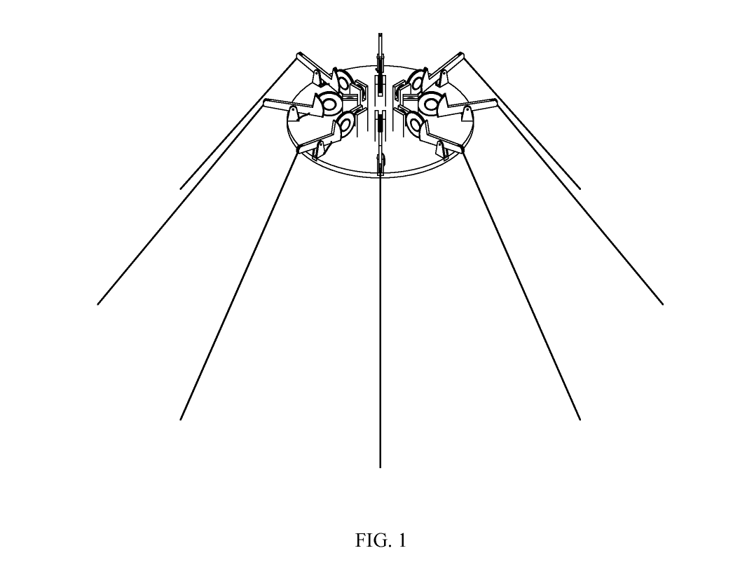

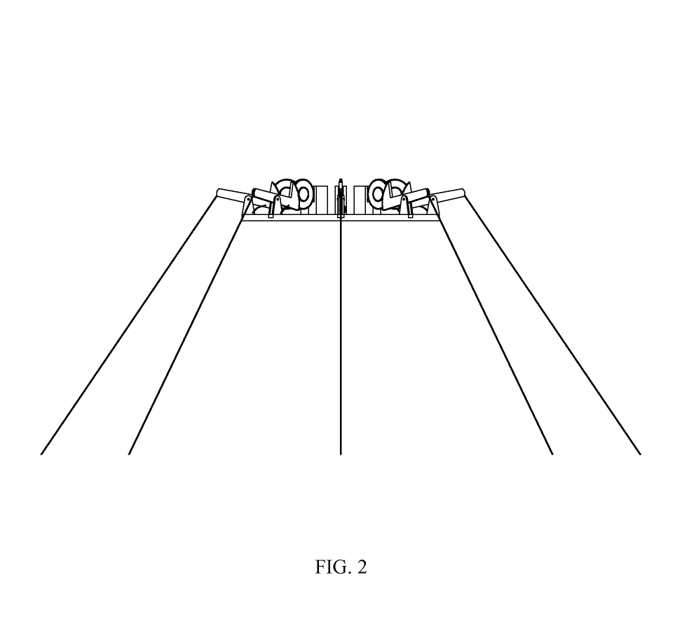

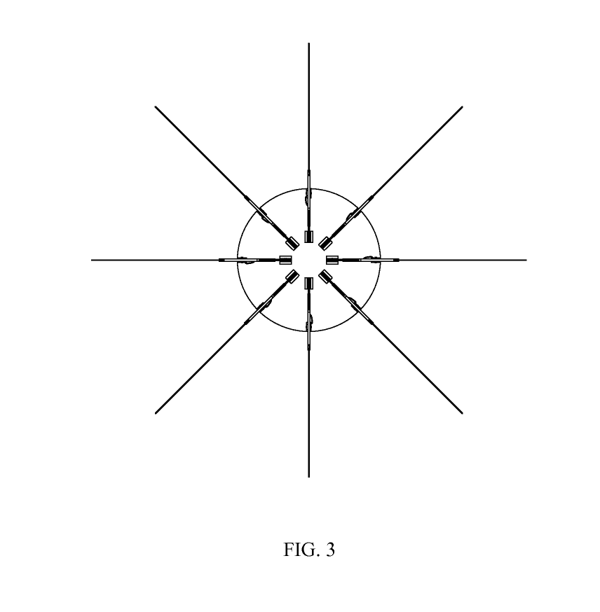

The present invention is a renewable energy system for harnessing the energy transported by ocean surface waves. In the preferred embodiment of the present invention, the renewable energy system is designed for offshore installation and comprises a platform, a plurality of energy generation units, and a plurality of anchors. An example embodiment of the renewable energy system is shown in FIGS. 1-3.

The renewable energy system comprises a platform. In the preferred embodiment of the present invention, the platform is circular in design and comprises an upper surface and a lower surface. However, the present invention is not limited with respect to the specific design of the platform and the design may differ across various embodiments of the present invention. The platform is buoyant and serves as a base structure for supporting the energy generation units of the renewable energy system on the upper surface of the platform.

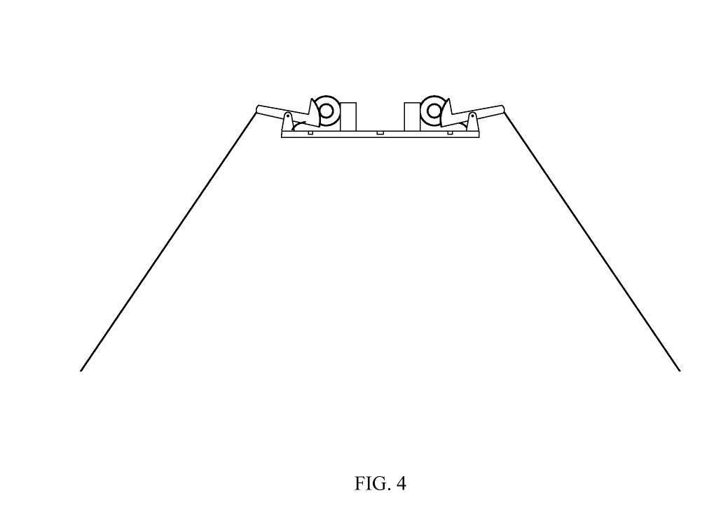

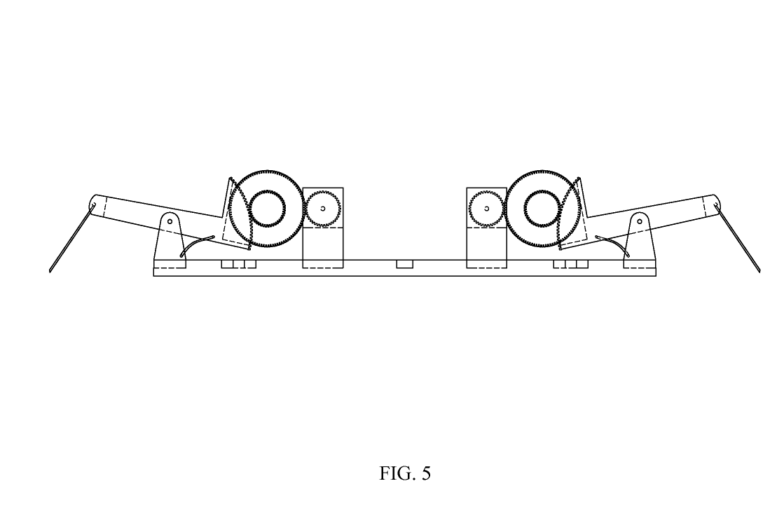

The renewable energy system further comprises a plurality of energy generation units. The present invention is not limited with respect to the specific number of energy generation units that may be utilized by the renewable energy system. In the preferred embodiment of the present invention, the energy generation units are identical to one another. Each energy generation unit comprises a support structure and a fork. The support structure may be mounted and secured to the upper surface of the platform. The support structure comprises a pivot mechanism via which the fork is pivotally attached to the support structure. The fork comprises a first end, an elongated central portion, and a rounded second end. The first end of the fork comprises an anchor point. In the preferred embodiment of the present invention, the elongated central portion of the fork is pivotally attached to the pivot mechanism of the support structure. The rounded second end comprises a plurality of gear teeth and a mounting point for a return mechanism. The return mechanism is capable of returning the fork to its original position following each stroke of the fork during operation of the renewable energy system. In the preferred embodiment of the present invention, the return mechanism comprises a return spring. Each energy generation unit further comprises a first, small gear and a second, large gear. The small gear is positioned in a manner such that the gear teeth of the small gear are engaged by the gear teeth located at the rounded second end of the fork. The large gear is concentric to the small gear and rotation of the small gear is translated to the large gear via a one-way clutch. The one-way clutch ensures that the small gear and the large gear are able to rotate in a single direction. The energy generation unit further comprises an electrical generator. The electrical generator comprises a plurality of gear teeth that are capable of engaging the gear teeth of the large gear. The electrical generator is mounted and secured to the upper surface of the renewable energy system platform as shown in FIG. 4 and FIG. 5. In the preferred embodiment of the present invention, the energy generation units are mounted in pairs to the upper surface of the renewable energy system platform.

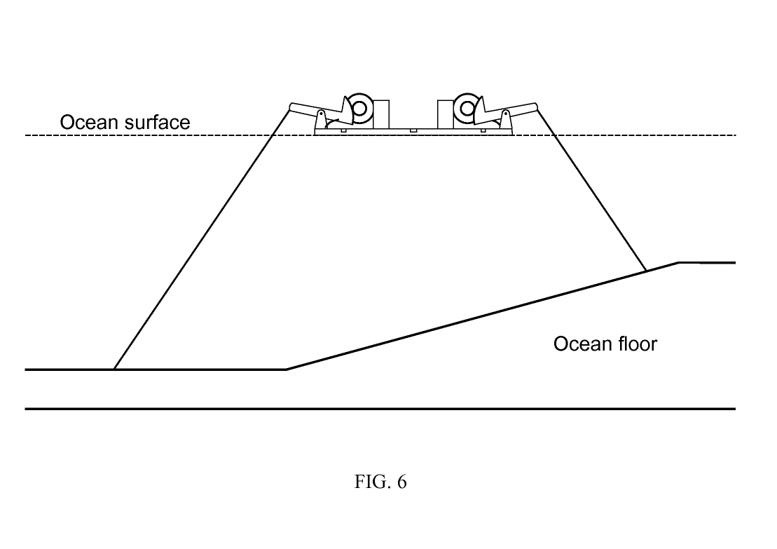

The renewable energy system further comprises a plurality of anchors. The number of anchors corresponds directly to the number of energy generation units in use by the renewable energy system. In the preferred embodiment of the present invention, each anchor comprises a chain with a first end and a second end. The first end of the anchor is secured to the anchor point located at the first end of the energy generation unit fork. The second end of the anchor may be embedded, entrenched, or otherwise secured in place on the ocean floor. The anchor chains are mounted to the ocean floor at an angle in order to maintain the platform in a central position relative to all of the anchor points. The renewable energy system anchors are not required to be of the same length as shown in FIG. 6. As a result, the renewable energy system may be utilized in an ocean location featuring an uneven ocean floor. In this sense, the ocean floor does not require any flattening or additional work done on the ocean floor in order to accommodate the renewable energy system. Rather, each energy generation unit of the renewable energy system may comprise an anchor chain of different length based on the height of the portion of the ocean floor to which each energy generation unit is anchored.

As previously discussed, the renewable energy system is capable of harnessing the energy transported by ocean surface waves for useful work. The renewable energy system is intended for use at an offshore location and is anchored to the ocean floor via the plurality of anchors that are attached to the energy generation units of the renewable energy system. The renewable energy system platform is capable of floating on the ocean surface. Movement of the platform from the ocean surface waves causes the energy generation unit forks to pivot due to the tension in the anchor chains attached to the first ends of the forks. As each fork pivots, the gear teeth located at the rounded second end of the fork engage the gear teeth of the small gear, causing the small gear to rotate. This rotational motion is translated to the large gear via the one-way clutch, causing the large gear to rotate in the same direction as the small gear. The gear teeth of the large gear engage the gear teeth of the electrical generator, causing the electrical generator to convert the mechanical energy to electrical energy. Following each stroke of the energy generating unit fork, the fork is brought back to its original position via the return mechanism and the one-way clutch.

Although the present invention has been explained in relation to its preferred embodiment, it is understood that many other possible modifications and variations can be made without departing from the spirit and scope of the present invention.

What is claimed is:

1. A renewable energy system based on ocean surface waves comprises:
a buoyant platform;
a plurality of energy generation units;
a plurality of anchors;
each of the energy generation units being radially positioned around said buoyant
each of the energy generation units comprises a support structure and a fork;
the support structure being mounted onto the buoyant platform;
the fork being pivotally connected to said support structure;
the fork protruding over the buoyant platform;
a corresponding anchor from the plurality of anchors being coupled to the fork;
the corresponding anchor being overhung from the buoyant platform;
each of the energy generation units having a return mechanism;
the return mechanism being operatively coupled between the fork and the buoyant platform;

2. The renewable energy system based on ocean surface waves as claimed in claim 1, wherein the buoyant platform floats on a body of water.

3. The renewable energy system based on ocean surface waves as claimed in claim 1, wherein the plurality of anchors is secured to the bed of a body of water.

4. The renewable energy system based on ocean surface waves as claimed in claim 1, wherein the horizontal linear movement of the buoyant platform created from waves within a body of water is converted from mechanical energy initialized by the buoyant platform into electrical energy captured by the plurality of energy generation units.

5. The renewable energy system based on ocean surface waves as claimed in claim 1, wherein the vertical linear movement of the buoyant platform created from waves within a body of water is converted from mechanical energy initialized by the buoyant platform into electrical energy captured by the plurality of energy generation units.

6. The renewable energy system based on ocean surface waves as claimed in claim 1, wherein the reciprocating movement of the buoyant platform created from waves within a body of water is converted from mechanical energy initialized by the buoyant platform into electrical energy captured by the plurality of energy generation units.

7. The renewable energy system based on ocean surface waves as claimed in claim 1, wherein a set of gears for each energy generation unit captures mechanical energy from the buoyant platform with maximum efficiency.

8. The renewable energy system based on ocean surface waves as claimed in claim 1, wherein the return mechanism recoils the fork from an actuated position to a resting position.

9. A renewable energy system based on ocean surface waves comprises:
a buoyant platform;
a plurality of energy generation units;
a plurality of anchors;
each of the energy generation units being radially positioned around said buoyant
each of the energy generation units comprises a support structure, a cable, and a pulley;
the support structure being mounted onto the buoyant platform;
the pulley being rotatably connected to said support structure;
the pulley protruding over the buoyant platform;
the cable being tensioned through the pulley and coupled to a corresponding anchor from the plurality of anchors;
the corresponding anchor being overhung from the buoyant platform;
each of the energy generation units having a return mechanism;
the return mechanism being coupled to the cable opposite the corresponding anchor;

10. The renewable energy system based on ocean surface waves as claimed in claim 9, wherein the buoyant platform floats on a body of water.

11. The renewable energy system based on ocean surface waves as claimed in claim 9, wherein the plurality of anchors is secured to the bed of a body of water.

12. The renewable energy system based on ocean surface waves as claimed in claim 9, wherein the horizontal linear movement of the buoyant platform created from waves within a body of water is converted from mechanical energy initialized by the buoyant platform into electrical energy captured by the plurality of energy generation units.

13. The renewable energy system based on ocean surface waves as claimed in claim 9, wherein the vertical linear movement of the buoyant platform created from waves within a body of water is converted from mechanical energy initialized by the buoyant platform into electrical energy captured by the plurality of energy generation units.

14. The renewable energy system based on ocean surface waves as claimed in claim 9, wherein the reciprocating movement of the buoyant platform created from waves within a body of water is converted from mechanical energy initialized by the buoyant platform into electrical energy captured by the plurality of energy generation units.

15. The renewable energy system based on ocean surface waves as claimed in claim 9, wherein a set of gears for each energy generation unit captures mechanical energy from the buoyant platform with maximum efficiency.

16. The renewable energy system based on ocean surface waves as claimed in claim 9, wherein the return mechanism recoils the tensioned portion of the cable.
